(19) United States
(12) Patent Application Publication
(10) Pub. No.: US 2003/0177125 A1
(43) Pub. Date: Sep. 18, 2003

(54) Enhanced residential gateway and associated methods

(76) Inventor: Dmitrii Loukianov, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/101,667

(22) Filed: Mar. 18, 2002

(51) Int. Cl. G06F 7/00

(52) U.S. Cl. 707/10

(57) ABSTRACT

An enhanced residential gateway and associated methods is generally described. In accordance with one example embodiment of the invention, a method is presented comprising receiving a packet for transmission to a wide area network (WAN) from one of a plurality of coupled clients, analyzing at least a subset of content of the received packet to identify one or more characteristics of the received packet, and selectively modifying the received packet in accordance with one or more routing parameters from a routing parameters database based, at least in part, on the identified one or more characteristics of the received packet.

### TECHNICAL FIELD

Embodiments of the present invention generally relate to the field of data networks and, more particularly, to an enhanced residential gateway and associated methods for dynamic packet forwarding in a residential gateway.

### BACKGROUND

The term “residential gateway” colloquially refers to a class of networking appliances that communicatively couple a home, or small office computing environment with a portal to a wide area network (WAN). In this regard, a conventional residential gateway is often thought of as a modulator/demodulator (MODEM) to couple the resources (e.g., clients) of the LAN to the resources of a WAN, i.e., a telephony modem, a cable modem, a fiber modem, an xDSL modem, and the like.

The traditional approach for configuring elements of (e.g., the SOHO) LAN to access a WAN is to manually setup routing and “proxy server” parameters in each of the individual clients (e.g., individual electronic devices coupled to the LAN). A proxy server typically sits between a web browser application executing on a client and the WAN resources. In this regard, a proxy server typically fulfills two main roles. First, the proxy will temporarily store the content from each WAN access received through the proxy. This function of web caching can dramatically improve the perceived performance of the network connection vis-à-vis the client. Second, the proxy server may be employed as a content filter, established by an administrator of the LAN, restricting certain clients from select WAN content. An example of conventional residential gateway implementation is presented with reference to FIG. 1.

Turning briefly to FIG. 1, a block diagram of an example networking implementation utilizing a conventional residential gateway is depicted. As shown, the residential gateway 102 couples a LAN 104 of clients 106, 108, 110 to the resources 112, 114 of a WAN 116 through one or more portals, or service providers 118. As used herein, the portal infrastructure 118 may well include firewall facilities, network management provisioning server(s) to dynamically allocate each client a network address, network management services and the like. The portal 118 is typically offered by a network service provider, e.g., an internet service provider (ISP), an application service provider (ASP), etc., or by a Multiple Service Operator (MSO) (e.g., a cable access television (CATV) company, a telephone company offering Digital Subscriber Line (DSL) services, etc.). As described above, each of the clients are populated with a client-specific network management data structure 120, 122 and 124, respectively which, as depicted (122, 124), uniquely defines address information and proxy settings on a client-by-client basis.

While such conventional residential gateways have gone a long way towards bringing high-speed WAN access to the SOHO computing environment, they have a number of limitations, which inhibit widespread adoption in this market segment. One such limitation is that such conventional gateways require a level of network management skills that often exceed that of the typical SOHO customer. Thus, they are often forced to hire an outside consultant to come in and set up their LAN-WAN interface as well as each of the clients. Moreover, any time a service provider (e.g., an Internet Service Provider (ISP)) of the WAN is changed for any of the client(s) on the LAN, the consultant will typically have to come back in and change the routing parameters and proxy settings on the client to facilitate the WAN connection through the new ISP.

While the foregoing limitation affects people of limited technical skill, another limitation affects those with average, or above, technical skill. In particular, those skilled in the art will appreciate that insofar as the proxy settings reside on the client, they are vulnerable to change by a user of the client. To illustrate this limitation, take a home LAN 102 comprising a “parent” computer 106 and a “child” computer 108, each denoted by their primary user. Assume that the parent is of limited technical skill, at least when it comes to establishing the network connection between their LAN 104 and WAN 116, and that the parent hires a consultant to come in and set everything up. Once the consultant has established the proxy settings 120 and 122, respectively, including the designation of an ASP 114 to filter WAN content accessible by the “child” computer 108, the settings on the child computer 108 are vulnerable to change by a child that has average (or above) computing skills. Thus, the client-based proxy management approach of traditional residential gateways is subject to security breach of the proxy settings by a computer literate individual of mere novice-level skills.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram of a networking environment including a conventional residential gateway supporting a number of clients, wherein the proxy settings are established and maintained within the individual clients;

FIG. 2 is a block diagram of an example enhanced residential gateway, according to one example embodiment of the present invention;

FIG. 3 graphically illustrates an example management data structure suitable for use in the enhanced residential gateway to facilitate dynamic routing, according to one example embodiment of the present invention;

FIG. 4 is a flow chart of an example method for dynamically routing content performed by the enhanced residential gateway, in accordance with one example embodiment of the present invention;

FIG. 5 is a graphical illustration depicting the interrelation of network components in support of the dynamic routing features of the enhanced residential gateway, in accordance with one example embodiment of the present invention;

FIG. 6 is a block diagram of an example networking environment including an enhanced residential gateway, in accordance with one example implementation of the present invention; and

FIG. 7 is a block diagram of an example storage medium comprising a plurality of executable instructions which, when executed, cause an accessing machine to implement one or more aspects of the enhanced residential gateway, in accordance with an alternate embodiment of the present invention.

### DETAILED DESCRIPTION

In the following description, numerous specific details are set forth. However, it is understood that embodiments of the invention may be practiced without these specific details. In other instances, well-known circuits, structures and techniques have not been shown in detail so as to not obscure the understanding of this description.

Embodiments of the present invention are generally directed to an enhanced residential gateway and associated methods. In this regard, an enhanced residential gateway (ERG) is introduced incorporating a dynamic routing engine. As will be disclosed more fully below, the ERG establishes and maintains a data structure comprising routing rules and/or proxy information associated with each of one or more clients serviced by the ERG. The information contained within the management data structure is populated, at least in part, by service providers, e.g., internet service provider(s) ISP(s) and application service provider(s) ASP(s), servicing each of the ERG clients. As will be developed more fully below, the dynamic routing engine works employs the management data structure to facilitate dynamic routing of content from/to ERG client(s) based, at least in part, on the routing rules and/or service information associated with such client(s). It will be appreciated, from the discussion to follow, that such dynamic routing services of the ERG may well be employed in support of further advanced content management features such as, for example, parental control features, browser redirection, and the like.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may well be combined in any suitable manner in one or more embodiments.

### Example Enhanced Residential Gateway (ERG)

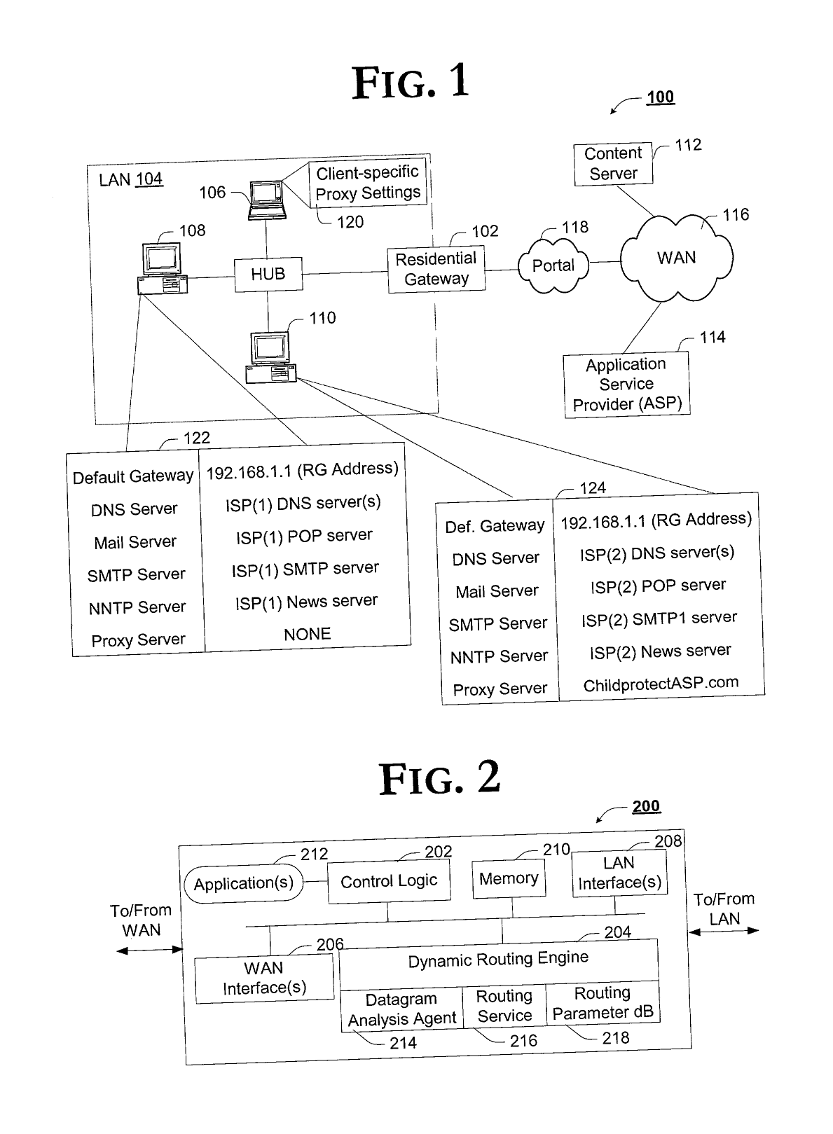

FIG. 2 illustrates a block diagram of an example enhanced residential gateway representative of one example embodiment of the present invention. In accordance with the illustrated example implementation of FIG. 2, enhanced residential gateway (ERG) 200 is depicted comprising control logic 202, a dynamic routing engine 204, WAN interface(s) 206, LAN interface(s) 208, memory 210 and, optionally, one or more application(s) 212, each logically coupled as depicted.

In accordance with one example embodiment of the present invention, dynamic routing engine 204 is depicted comprising a datagram analysis agent 214, routing service(s) 216 and a routing parameter database 218. As introduced above, and developed more fully below, the elements 214-218 of dynamic routing engine 204 selectively implement dynamic routing of content to/from clients and WAN service(s) on a client-by-client basis. Those of ordinary skill in the art will appreciate that, although depicted as a number of disparate elements within dynamic routing engine 204, one or more of elements 214-218 may well be combined into a single, multi-function element without deviating from the spirit and scope of the present invention. Moreover, although illustrated in block diagram form, those of ordinary skill in the art will appreciate that one or more elements of the enhanced residential gateway 200 such as, e.g., the dynamic routing engine 204, may well be implemented in hardware, software or a combination thereof.

Control logic 202 coordinates the overall operation of the enhanced residential gateway 200. As will be developed more fully below, control logic 202 selectively invokes an instance of dynamic routing engine 204 to populate and/or manage the content of routing parameter database 218 with routing information and/or proxy settings for each of one or more clients serviced by ERG 200. Moreover, when ERG 200 receives content from a client (e.g., on a LAN port), control logic 202 invokes an instance of dynamic routing engine 204 to selectively modify and/or forward the received content to WAN resources based, at least in part, the content of the routing parameter database 218 associated with an identified source of the content.

In accordance with certain embodiments of the present invention, control logic 202 also selectively invokes and executes one or more application(s) 212 in support of additional content management features of the ERG 200. That is, in accordance with certain embodiments of the present invention, ERG 200 includes applications 212 to facilitate parental control features, redirection to an MSO homepage, redirection of service content or other dedicated names, and the like. A further description of the value-added services facilitated by the dynamic packet forwarding described herein will be developed more fully below.

As used herein, control logic 202 is intended to represent any of a wide variety of logic device(s) and/or content which coordinates the overall operation of the dynamic routing engine 202. In this regard, control logic 202 may well be comprised of a microprocessor, a microcontroller, field-programmable gate array (FPGA), application specific integrated circuit (ASIC), executable content to implement such control features and/or any combination thereof.

Each of wide area network (WAN) interface(s) 206 and local area network (LAN) interface(s) 208 are intended to represent such interfaces as they are commonly known in the art. In this regard, WAN interface(s) 206 is intended to represent the hardware, software and/or protocol stacks necessary to enable ERG 200 to communicate with WAN resources. Similarly, LAN interface(s) 208 are intended to represent the hardware, software and/or protocol stacks necessary to enable ERG 200 to communicate with LAN resources. As used herein, WAN interface(s) 206 include WAN ports (not particularly denoted) through which the interface is coupled to a WAN. Similarly, LAN interface(s) 208 include LAN ports (not particularly denoted) through which the interface is coupled to a LAN.

As used herein, memory 210 is used to temporarily store content as it passes through ERG 200 between LAN client(s) and WAN resources. In this regard, memory 210 may well include one or more of a LAN buffer to receive content from LAN client(s) for delivery to a WAN port, a WAN buffer to receive content from a WAN resource for delivery to a LAN port, and/or management data structures such as, e.g. in particular implementations, routing parameter DB 218.

According to one example embodiment, packets received from a LAN port (i.e., via LAN interface(s) 208) are received in a LAN buffer (not particularly denoted) of memory 210. Dynamic routing engine 204 pulls a packet from the LAN buffer of memory 210 for analysis and selective modification and forwarding to the portal 118 based, at least in part, on the content of routing parameter DB 218 associated with the identified source of the packet. Similarly, packets received from a WAN port (i.e., via WAN interface(s) 206) are received in a WAN buffer (not particularly denoted) of memory 210. Dynamic routing engine pulls content from the WAN buffer for delivery to LAN clients. As used herein, memory 210 may well be implemented with volatile memory, non-volatile memory or a combination thereof. Moreover, although illustrated as a separate module, it should be apparent that memory 210 may well be implemented as an element of one or more of WAN interface(s) 206, LAN interface(s) 208, and/or dynamic routing engine 204.

As shown, dynamic routing engine 204 is depicted comprising a datagram (or, packet) analysis agent 214, routing service 216 and routing parameter database (DB) 218, the function of each of which will be described in more detail below. In general, dynamic routing engine 204 receives content from a port on LAN interface(s) 208 at the routing service 216. Analysis agent 214 is selectively invoked to analyze at least a subset of the content of the received content (e.g., a packet or datagram) to identify one or more characteristics of the received packet. More particularly, reviews the received packet for indication(s) of one or more of a source of the packet, a target of the packet, an Internet protocol (IP) port associated with the packet and/or a protocol associated with the packet. Once such characteristics are identified, if any, analysis agent 214 compares the identified packet characteristics against information contained within the routing parameter database 218. Based, at least in part, on the identified packet characteristics, and the information contained within the routing parameter DB 218, analysis agent 214 selectively modifies the packet before delivery to a suitable WAN port via routing service 216. According to one embodiment, selective modification refers to dynamically altering the routing information contained within the received packet in accordance with the routing parameters identified in the routing parameters database. In an alternate embodiment, analysis agent 214 may well encase the received packet in a “wrapper”, the wrapper including at least a subset of the routing parameters taken from the routing parameters database (e.g., a routing wrapper).

As will be developed more fully below, dynamic routing engine 204 employs one or more of a number of network management protocols to work in conjunction with the LAN, portal and/or service provider infrastructure to populate the routing management database 218. In this regard, routing engine 204 may well utilize the dynamic host configuration protocol (DHCP), the simple network management protocol (SNMP), the universal plug and play protocol (UPnP) and the like. As used herein, the DHCP is defined by the Internet Engineering Task Force (IETF) Request for Comments 2131 (RFC 2131) published in March of 1997; the SNMP protocol is described by IETF RFC 1157, published in May of 1990; while the UPnP protocol is generally described by IETF RFC 2572, published in April of 1999; each of which, along with associated their RFCs are generally incorporated herein by reference for all purposes.

Thus, routing parameter database 218 is dynamically populated for each ERG client by one or more of the, LAN infrastructure (e.g., address provisioning server(s)), portal infrastructure 118 (e.g., DHCP server, etc.) and/or subscribed service providers (e.g., ISP, ASP, etc.) employed by each of the individual clients. That is, the routing and proxy information associated with individual ones of the client(s) supported by ERG 200 is populated by the portal infrastructure and/or service provider(s) using any of the aforementioned DHCP, SNMP, UPnP protocol(s), or extensions thereof. Since the operation of the ERG 200 is at least partially controlled by the LAN infrastructure (e.g., LAN DHCP service), the portal infrastructure 118 and/or the service provider(s), the routing settings and proxy information maintained for each of the clients is much more secure against tampering than the conventional approach. Those of ordinary skill in the art will also appreciate that moving the management of such routing and proxy information to the ERG 200 alleviates the end-user of this management burden.

### Example Data Structure(s)

Turning to FIG. 3 a graphical representation of an example routing parameters data structure 300 is presented, suitable for use in accordance with the dynamic routing engine. According to one example implementation, data structure 300 may well be used as a routing parameters database 218 of ERG 200. As used herein, the term database is intended to represent any of a wide variety of data structures, and is not necessarily intended to denote a single type of data structure or accessing protocol for all embodiments.

In accordance with the illustrated example implementation of FIG. 3, routing parameters data structure 300 is presented comprising routing rules 304 for each of a plurality of client(s) 302 serviced by a residential gateway incorporating the teachings of the present invention. Although illustrated as a two-dimensional data structure organized by source address(es) 302, those of ordinary skill in the art will appreciate that data structures of greater or lesser complexity may well be substituted without deviating from the spirit and scope of the present invention.

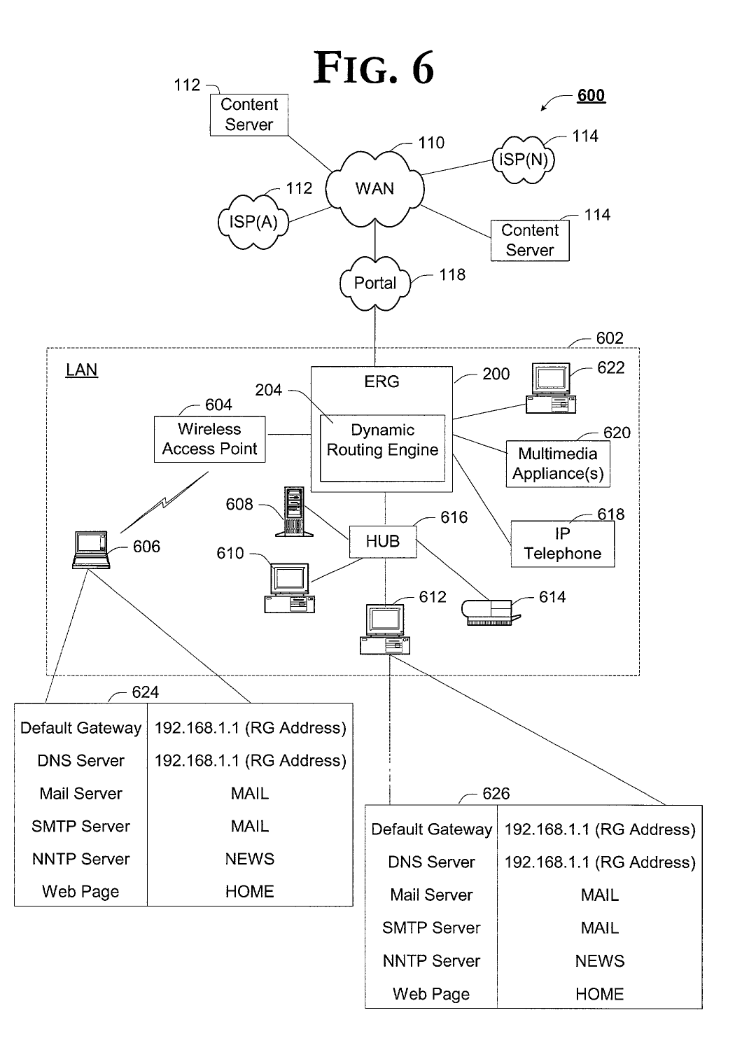

As introduced above in accordance with one example embodiment of the present invention, the content of routing parameters data structure 300 is populated, at least in part, by the servicing infrastructure for each of the clients supported by an ERG 200. That is, the content of the routing parameters data structure 300 is populated using one or more of DHCP, SNMP, UPnP, and the like by servicing providers of one or more of the LAN, WAN and/or portal. Consequently, the previously autonomous data structures maintained by each of the clients are populated with the same content that simply directs the client to the ERG 200 (see, e.g., data structures 624 and 626 associated with clients 606 and 612, respectively of FIG. 6). The routing parameters data structure 300 is then employed by the ERG 200 to dynamically route content to/from such clients. Thus, ERG 200 introduces a centralized routing parameters database that controls the content routed to/from each of the clients on an individualized basis and is, in at least some respects, automatically provisioned by the service providers.

### Example Operation and Implementation

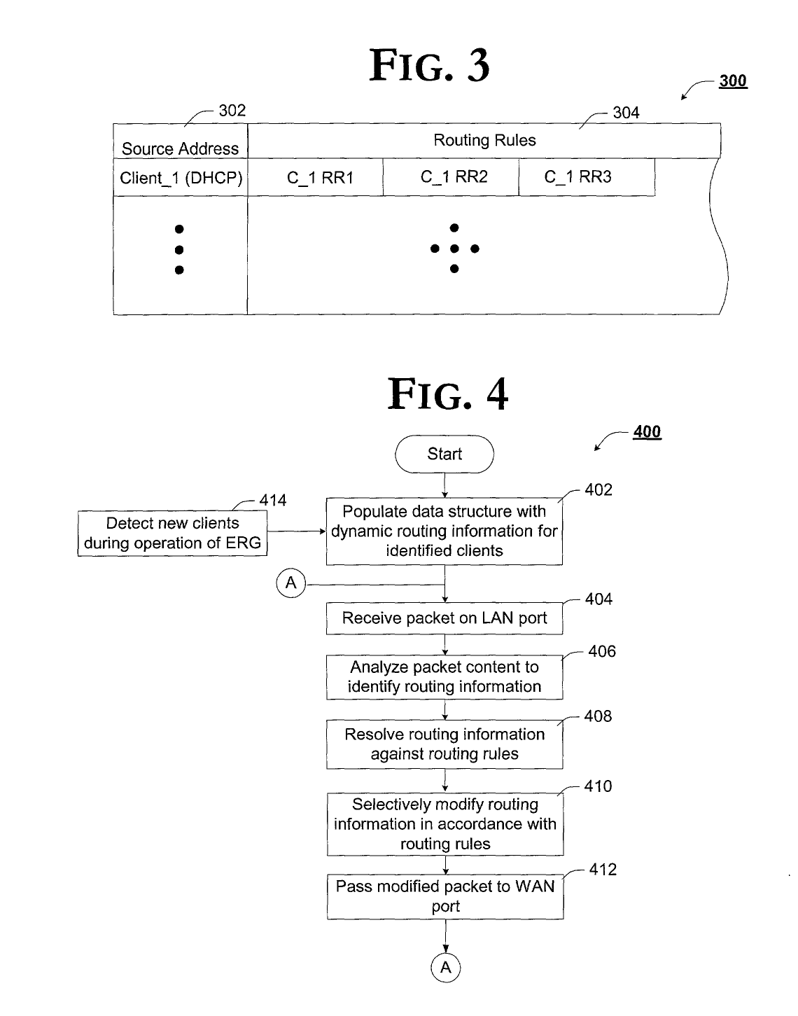

Having introduced the operating environment and architectural elements of the ERG 200, above, attention is now directed to FIGS. 4-7, wherein an example implementation of the dynamic routing features of the enhanced residential gateway 200 is presented in greater detail. For ease of illustration, and not limitation, the methods of FIGS. 4-7 will be developed with continued references to FIGS. 2 and 3, as appropriate. Nonetheless, it is to be appreciated that the teachings of FIGS. 4-7 may well be implemented in alternate network architectures/configurations without deviating from the spirit and scope of the present invention.

FIG. 4 is a flow chart of an example method for dynamically routing content performed by the enhanced residential gateway, in accordance with one example embodiment of the present invention. In accordance with the illustrated example embodiment of FIG. 4, the process begins with block 402 wherein ERG 200 populates a data structure with routing information for identified client(s). More particularly, as introduced above, upon an initialization event control logic 202 identifies one or more clients coupled to the ERG 200 through one or more LAN interface(s) 208. According to one example implementation, control logic 202 selectively invokes an instance of dynamic routing engine 204 to establish at least one entry in a database in which to maintain routing parameters (e.g., routing rules, addresses, proxy information, and the like) associated with each of the one or more identified client(s) of the ERG 200. As will be developed more fully below, in accordance with one example embodiment, ERG 200 can detect the addition of new clients (e.g., through universal plug-n-play (UPnP) features) and will update/modify the established routing parameters database 218, accordingly.

Once the clients are identified, the routing parameters (or, rules) for each of the clients are established, at least in part, by the service providers of each of the respective clients. As introduced above, dynamic routing engine 204 employs one or more management protocols such as, e.g., DHCP, SNMP, UPnP and/or associated protocols to communicate with the service provider infrastructure to receive the routing address(es) and proxy information for each of the respective clients supported by the infrastructure. Once the routing parameters DB 218 is established, ERG 200 is ready to begin dynamically routing content to/from each of a plurality of clients based, at least in part, on the routing rules established and maintained within the routing parameters DB 218.

Accordingly, the process continues with block 404 wherein ERG 200 receives content from one or more LAN clients. According to one example embodiment, routing service 216 of dynamic routing engine receives packet(s) from a client via a LAN port of LAN interface(s) 208. In alternate embodiments, the packets received via LAN port(s) are first buffered, e.g., in memory 210 before being accessed by dynamic routing engine. In either case, the packets are received by dynamic routing engine 204 at the routing service 216.

In block 406, the packet is passed to datagram analysis agent 214 to identify routing information associated with the packet. As introduced above, analysis agent 214 analyzes at least a subset of the content of the packet for an indication of one or more of the source of the packet, the target(s) of the packet, a receive port of the packet, a quality of service of the packet, and the like.

Once this information is identified, datagram analysis agent 214 compares this content against routing information contained within the routing parameters database 218, block 408. According to one example embodiment, analysis agent 214 identifies the source address of the received packet, and searches the routing parameters database 218 for routing parameters (rules) associated with the identified source address. As introduced above, at least a subset of the routing parameters are dynamically established and managed within the routing parameters database 218 by the service providers using one or more of a network management protocol, e.g., DHCP, SNMP, UPnP, and the like.

In block 410, analysis agent 214 selectively modifies the routing information of the received packet based, at least in part, on the information associated with the identified source in the routing parameters database 218. That is, analysis agent 214 identifies service provider information, proxy information and the like associated with the source client, and dynamically modifies the routing information of the packet, as necessary, to enable proper routing of the packet. In this regard, if a client is subscribed to a content filter provided by an ASP, analysis agent 214 modifies the routing information of the packet to pass the packet to the ASP, where the ASP selectively forwards the packet to the targeted WAN resource if it satisfies the filter criteria.

Once the packet is modified in accordance with the routing parameters database 218, analysis engine 214 passes the packet back to routing service 216, which passes the modified packet to a WAN port, block 412. As introduced above, routing service passes the selectively modified packet to a WAN port of WAN interface(s) 206 for transmission to one or more WAN resources, before the process continues with block 404.

As introduced above, while dynamic routing engine 204 is attending to the dynamic routing of content on behalf of one or more clients, ERG 200 is nonetheless capable of dynamically detecting the addition of clients to the ERG, block 414. That is, control logic 202 in cooperation with LAN interface(s) 208 can sense the addition of a new client of the ERG 200. As introduced above, LAN interface(s) 208 includes UPNP resources that, upon detecting the addition of a client, or the removal of a client from the services of ERG 200, provide control logic with an indication denoting the addition or removal. In response, control logic 202 selectively modifies the content of routing parameters database 218 to add or remove routing parameters associated with the addition or removal of such clients, respectively.

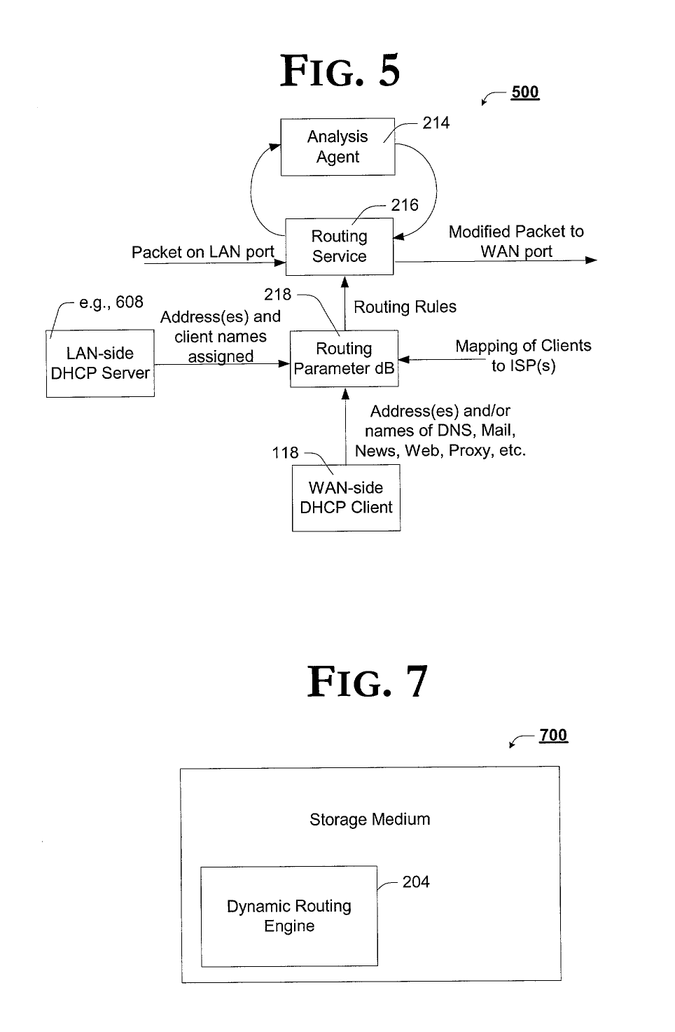

FIG. 5 is a graphical illustration of the method introduced above, in FIG. 4. That is, FIG. 5 graphically illustrates the interoperation of network components in support of the dynamic routing features of the enhanced residential gateway, in accordance with one example embodiment of the present invention. As shown, the routing parameters database 218 receives content from one or more of the LAN side infrastructure, e.g., DHCP server(s), portal infrastructure 118 (e.g., DHCP server(s)), and/or WAN service provider(s) (e.g., ISPs, ASPs, and the like).

As shown, ERG 200 receives a packet from a client at a LAN port of LAN interface(s) 208, which is provided to routing service 216. Routing service forwards the packet to analysis agent 214. As introduced above, analysis agent 214 compares at least a subset of the content of the received packet against routing parameter information contained within the routing parameters database 218. In one example embodiment, analysis engine 214 identifies one or more of an indication of the source of the packet, an indication of the receive port, and/or an indication of the target of the packet to identify one or more routing parameters associated with the packet. Once the routing parameters are identified, if any, analysis agent 214 selectively modifies the packet with additional/alternative routing information as dictated by the routing parameter database 218, before forwarding the selectively modified packet to the routing service 214 for transmission to the WAN.

Having introduced an enhanced residential gateway and associated methods for implementing dynamic routing services, those of ordinary skill in the art will appreciate that such innovation may well be employed to support a number of value-added features. In this regard, ERG 200 may well include one or more applications 212 to implement parental control features, redirection to a homepage associated with the MSO and/or redirection to SYSLOG or other dedicated names.

As used herein the parental control feature allows, for any client, that selected traffic may be routed to a dedicated proxy or blocked completely. That is, ERG 200 may well implement a filter application similar to that described above with respect to an ASP.

As used herein, redirection to a homepage associated with the portal infrastructure (e.g., MSO) provides that, for appropriate clients, an automatic redirection of content to a predefined destination may be used for subscriber self-provisioning. That is, when the user of a client is not subscribed to an ISP or the contract has expired, all WAN traffic received by the ERG from that client may be redirected to a subscription server of the portal. The client will not be able to access the WAN, and regardless of the address used in a “browser” application, the user will only see the subscription page. Once the contract is in place, the routing rule may be changed through one or more of the network management protocol(s), e.g., SNMP, UPnP, and the like.

According to one example implementation, service-specific content such as that associated with, for example, network backup devices, SYSLOG devices, or other network management services may be dynamically redirected for load sharing and/or maintenance purposes. In this regard, routing rules are dynamically established which dynamically route content to specific service devices based, at least in part, on the current loading of such devices, the operational state of the devices (e.g., exhibiting a failure mode) and the like.

FIG. 6 is a block diagram of an example networking environment including an enhanced residential gateway, in accordance with one example implementation of the present invention. As depicted in FIG. 6, the difference between conventional network 100 and the network 600 depicted in FIG. 6 is the introduction of enhanced residential gateway 200 and the associated dynamic routing features provided therein. Thus, in accordance with the illustrated example embodiment of FIG. 6, network 600 is depicted comprising a LAN 602 including a plurality of electronic appliances (e.g., 618, 620) and/or computing device(s) (604-616, 622) coupled to one or more resources 112, 114 of a WAN 110 by an enhanced residential gateway 200 through a portal infrastructure 118. Unlike the conventional network 100 depicted in FIG. 1, the ERG clients 602-622 may well include a routing data structure but, as particularly denoted with reference to elements 624 and 626, the routing data structure within each of the clients merely directs content to the ERG 200. In this regard, ERG 200 functions as a proxy for each of the LAN clients with respect to the portal infrastructure and WAN resources.

### ALTERNATE EMBODIMENT(S)

FIG. 7 is a block diagram of an example storage medium comprising a plurality of executable instructions which, when executed, cause an accessing machine to implement one or more aspects of the enhanced residential gateway, in accordance with an alternate embodiment of the present invention.

Embodiments of the present invention may be provided as a computer program product which may include a machine-readable medium having stored thereon instructions which may be used to program a computer (or other electronic devices) to perform processes according to those described herein. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative of, rather than limiting the scope and coverage of the claims appended hereto.

What is claimed is:

1. A method comprising:
receiving a packet for transmission to a wide area network (WAN) from one of a plurality of coupled clients;
analyzing at least a subset of content of the received packet to identify one or more characteristics of the received packet; and
selectively modifying the received packet in accordance with one or more routing parameters obtained from a routing parameters database based, at least in part, on the identified one or more characteristics of the received packet.

2. A method according to claim 1, further comprising:
transmitting the selectively modified packet to a WAN port.

3. A method according to claim 1, the element of receiving a packet comprising:
receiving the packet from one of the plurality of clients through a local area network (LAN) port of a host residential gateway; and
providing the received packet to a dynamic routing engine to perform the analyzing and selectively modifying elements.

4. A method according to claim 3, further comprising:
sending the selectively modified packet from the dynamic routing engine to a wide area network (WAN) port of the host residential gateway for transmission to the WAN.

5. A method according to claim 1, the element of analyzing at least a subset of content comprising:
identifying as packet characteristics an indication of one or more of a source of the packet, internet protocol (IP) port associated with the packet, a target of the packet, and/or protocol associated with the packet; and
comparing the identified characteristics against information contained within a routing parameters database.

6. A method according to claim 5, the comparing element comprising:
searching the routing parameters database to detect an entry associated with the identified packet characteristics; and
identifying routing parameters associated with the detected entry.

7. A method according to claim 6, wherein the packet is selectively modified in accordance with the identified routing parameters, if any, associated with the detected entry.

8. A method according to claim 7, wherein selectively modifying the packet comprises replacing routing information in the received packet with routing parameters identified within the routing parameters database.

9. A method according to claim 7, wherein selectively modifying the packet comprises encasing the received packet in a routing wrapper, the routing wrapper including at least a subset of the identified routing parameters associated with the detected entry.

10. A method according to claim 1, wherein selectively modifying the packet comprises replacing routing information in the received packet with routing parameters associated with the identified source of the packet and contained within a routing parameters database.

11. A method according to claim 1, wherein selectively modifying the packet comprises encasing the received packet in a routing wrapper, the routing wrapper including at least a subset of the identified routing parameters associated with the identified source of the packet.

12. An apparatus comprising:
a local area network (LAN) interface to receive a packet from one or more client(s); and
a dynamic routing engine, coupled with the LAN interface, to analyze at least a subset of the received packet to identify one or more packet characteristics, and to selectively modify the packet in accordance with one or more routing parameters associated with the identified packet characteristics.

13. An apparatus according to claim 12, the LAN interface comprising:
one or more LAN ports, communicatively coupling the apparatus to the one or more client(s).

14. An apparatus according to claim 12, the dynamic routing engine comprising:
a routing service, coupled with the LAN interface and a wide area network (WAN) interface, to receive a packet from the LAN interface and forward a selectively modified version of the packet to the WAN interface.

15. An apparatus according to claim 14, the dynamic routing engine further comprising:
an analysis agent, coupled to the routing service, to review at least a subset of the received packet to identify an indication of one or more of a source of the packet, an internet protocol (IP) port associated with the packet, a target of the packet, and/or a protocol associated with the packet.

16. An apparatus according to claim 15, wherein the analysis agent searches a routing parameters database to identify routing parameters, if any, associated with the packet based, at least in part, on the identified indication(s).

17. An apparatus according to claim 16, wherein the analysis agent selectively modifies the packet with at least a subset of the identified routing parameters.

18. An apparatus according to claim 17, wherein the analysis agent selectively modifies the packet by encasing the packet in a routing wrapper, the routing wrapper including at least a subset of the identified routing parameters associated with the packet.

19. An apparatus according to claim 17, wherein the analysis agent selectively modifies the packet by replacing routing information in the received packet with routing parameters obtained from the routing parameters database.

20. An apparatus according to claim 17, wherein the analysis agent forwards the selectively modified packet to the routing service for delivery to the WAN interface.

21. An apparatus according to claim 12, the dynamic routing engine comprising:
an analysis agent, responsive to the LAN interface, to review at least a subset of the received packet to identify an indication of one or more of a source of the packet, an internet protocol (IP) port associated with the packet, a target of the packet, and/or a protocol associated with the packet.

22. An apparatus according to claim 21, wherein the analysis agent searches a routing parameters database to identify routing parameters, if any, associated with the packet based, at least in part, on the identified indication(s).

23. An apparatus according to claim 22, wherein the analysis agent selectively modifies the packet with at least a subset of the identified routing parameters.

24. An apparatus according to claim 23, wherein the analysis agent selectively modifies the packet by encasing the packet in a routing wrapper, the routing wrapper including at least a subset of the identified routing parameters associated with the packet.

25. An apparatus according to claim 23, wherein the analysis agent selectively modifies the packet by replacing routing information in the received packet with routing parameters obtained from the routing parameters database.

26. An apparatus according to claim 23, wherein the analysis agent forwards the selectively modified packet to a routing service of the dynamic routing engine for delivery to a wide area network (WAN) interface.

27. A storage medium comprising content which, when executed by an accessing machine, causes the machine to implement a dynamic routing engine, the dynamic routing engine to receive a packet from any of up to a plurality of communicatively coupled clients, analyze at least a subset of the received packet to identify one or more packet characteristics, and to selectively modify the packet in accordance with one or more routing parameters associated with the identified packet characteristics maintained in a routing parameters database.

28. A storage medium according to claim 27, wherein the content to implement the dynamic routing engine includes content to implement a routing service, to receive a packet from any of the plurality of clients through a local area network (LAN) interface, and to subsequently deliver a selectively modified representation of the packet to a wide area network (WAN) interface.

29. A storage medium according to claim 27, wherein the content to implement the dynamic routing engine includes content to implement an analysis engine, to review the received packet to identify an indication of one or more of a source of the packet, an internet protocol (IP) port associated with the packet, a target of the packet, and/or a protocol associated with the packet.

30. A storage medium according to claim 29, the content to implement the analysis engine further comprising content to search the routing parameters database for routing parameters associated with the identified packet characteristics.

31. A storage medium according to claim 30, the content to implement the analysis engine further comprising content to selectively modify the packet with at least a subset of the identified routing parameters from the routing parameters database.
